(19) United States
(12) Patent Application Publication
(10) Pub. No.: US 2019/0389243 A1
(43) Pub. Date: Dec. 26, 2019

(54) OPTICAL ILLUSION DEVICE

(71) Applicant: CHINA INDUSTRIES LIMITED, WOLVERHAMPTON WEST MIDLANDS (GB)

(72) Inventors: GRAEME JOHN TAYLOR, Much Wenlock Shropshire (GB); JAMES EDWARD ALEXANDER WYATT, Los Angeles, CA (US); MARK NEIL GASSON, LOS ANGELES, CA (US)

(21) Appl. No.: 16/479,151

(22) PCT Filed: Jan. 19, 2018
(86) PCT No.: PCT/GB18/50175

§ 371 Date: Jul. 18, 2019

(30) Foreign Application Priority Data
Jan. 20, 2017 (GB) 1701026.5
Oct. 2, 2017 (GB) 1716071.4
Oct. 2, 2017 (GB) 1716092.0

(51) Int. Cl. B44F 1/00; B44C 3/06; B44F 7/00; B29C 45/00; B29C 64/386; B33Y 50/00; B33Y 80/00; B33Y 10/00; G06T 15/50

(52) U.S. Cl. CPC B44F 1/00; B44C 3/06; B44F 7/00; B29C 45/0001; B29K 2105/0032; B33Y 50/00; B33Y 80/00; B33Y 10/00; G06T 15/50; B29C 64/386

(57) ABSTRACT

An optical illusion device and method of production is described. The method comprises producing a digital sculpt. A rendered visual image and a thinned digital sculpt are then produced from the digital sculpt. Next a digital thickness shell is produced from the thinned digital sculpt. Finally, the rendered visual image is employed to impart a lithophane depth map onto the digital thickness shell. The overall result is an optical illusion device comprising a negative image forming surface with a registered lithophane image imparted on thereon. When the optical illusion device is viewed from various angles (and with a light source placed behind it), the negative image forming surface appears to the viewer as a positive or convex model with a photographic image applied to the profiled surface. The illusion created is of a ‘panning’, three-dimensional photographic image, complete with improved detail due to the presence of the lithophane depth map.

### The present invention relates to the field of optical illusion devices and in particular to an optical illusion device based on a negative bust illusion device and a method of producing the same.

### BACKGROUND TO THE INVENTION

Since the times of early artists, people have endeavoured to create realistic likenesses of themselves, others, and other three-dimensional objects, to thereby impart a sense of presence. Such artistic reproductions have generally taken two dimensional forms, for example, paintings, and also three-dimensional forms, including various types of sculptures. In general, the two-dimensional reproductions are insufficient in reproducing three-dimensional presence having a large field of view; visual cues such as depth, shading and perspective have historically been impossible to reproduce in two dimensions to create a three-dimensional illusion other than for a discrete viewing point.

Sculptures, on the other hand, have proved generally better at visually imitating original objects, because of their dimensionality. To this end, artists have for a long time created busts and other three-dimensional representations of original objects to recreate presence of the original object.

One method of forming these dimensional recreations is to create a negative of a sculpture resembling a person or object or the concave surface of a death mask. As was noticed long ago, the negative bust itself can be used (with proper lighting) to create a three-dimensional impression and to convey presence, see for example U.S. Pat. No. 2,334,750. Typically, these negative busts are concave viewing surfaces having the same depth and features (typically facial) of the original three-dimensional object. They provide the illusion that the objects are represented by the negative bust, and that the image follows the viewer, and this is so particularly in the case of a death mask, since the eyes of the image turn in the direction of an observers changing viewing angle.

It is known that the perceptual illusion provided these negative masks can be improved by incorporating features that make the mask to look more realistic. For example, it is known from U.S. Pat. No. 5,407,391, to provide a negative translucent bust on which an image is rear projected to provide the illusion of a three-dimensional image of a bust having the coloration of the projected image. To facilitate image focus on the bust, and to improve viewing angle, the normal depth of the bust is flattened with respect to the original. In U.S. Pat. No. 5,407,391, the bust is used only for basic facial features. Features which surround the face, such as hair and ears, are imaged on the flat part of the translucent material surrounding the bust. Such features however lose the appearance of being three-dimensional since they are not formed on a negative image-forming relief surface.

U.S. Pat. No. 5,782,698 attempts to address these deficiencies by providing altered shading colourisation applied to the negative image-forming surface which is contrary to the actual image being viewed. The negative image-forming relief surface is provided with a shading coloration on its surface in such a way such that portions of the surface which are more recessed are generally made lighter in shade and portions of the surface which are less recessed are generally made darker in shade. This results in perception of a three-dimensional image which is enhanced when compared with those disclosed within U.S. Pat. Nos. 2,334,750 and 5,407,391.

Alternatively, U.S. Pat. No. 8,562,182 attempts to address these deficiencies by providing a distorted, two-dimensional rendering image of the subject of the negative image-forming surface. This distorted, two-dimensional rendering is then printed onto and registered with the negative image-forming surface. Although the devices disclosed within U.S. Pat. No. 8,562,182 result in the perception of a three-dimensional image which is enhanced when compared with those disclosed within U.S. Pat. Nos. 2,334,750 and 5,407,391 the devices and associated manufacturing process are highly complex and thus expensive for use within a commercial manufacturing process.

### SUMMARY OF INVENTION

It is therefore an object of an embodiment of the present invention to obviate or at least mitigate the foregoing disadvantages of the optical illusion devices known in the art.

It is a further object of an embodiment of the present invention to provide an improved optical illusion device which significantly improves the image sharpness and realness, as well as enhance the overall viewing enjoyment.

It is a further object of an embodiment of the present invention to provide an improved optical illusion device that is more efficient and economical to produce than those known in the prior art and thus suitable for use within a commercial manufacturing process.

According to a first aspect of the present invention there is provided a method of producing an optical illusion device the method comprising:
producing a digital sculpt;
producing a rendered visual image of the digital sculpt;
producing a thinned digital sculpt from the digital sculpt;
producing a digital thickness shell from the thinned digital sculpt;
employing the rendered visual image to impart a lithophane depth map onto the digital thickness shell.

The digital sculpt may be produced from a two-dimensional image.

Manipulation of the two-dimensional image may also be carried out to produce a greyscale image. Manipulation of the two-dimensional image may comprise manipulation of one or more properties of the two-dimensional image, namely colour; brightness; exposure; saturation; vibrancy; shadows; and highlights.

The method may further comprise adding detail to the digital sculpt. This detail or decoration may involve one or more of the following: creating embossed and debossed areas; image enhancement based on an original two-dimensional image to create a ‘photorealistic’ image; turning the digital sculpt into greyscale; and or adding tonal balancing, shadow depth, highlights and reflections to the digital sculpt. Adding detail at this stage helps maximise the effects of the final product produced at the end of the presently described process.

Producing the thinned digital sculpt may comprise altering the depth proportions and or angles and or surfaces of the digital sculpt.

Imparting the lithophane depth map onto the digital thickness shell may comprise projecting the rendered visual image into the digital thickness shell. In this embodiment, this stage may further comprise employing embossing and or debossing techniques to impart the lithophane depth map onto the digital thickness shell.

Alternatively, imparting the lithophane depth map onto the digital thickness shell may comprise projecting the rendered visual image onto a positive or outer surface of the digital thickness shell. Imparting the lithophane depth map into the digital thickness shell may further comprise employing embossing techniques to impart the lithophane depth map onto the outer surface of the digital thickness shell. This embossed digital thickness shell may then be employed to deboss the internal surface of the digital thickness shell.

Optionally the method further comprises inverting greyscale values of the rendered visual image.

Optionally the method further comprises smoothing one or more surfaces of the thinned digital sculpt.

Optionally the method further comprises inverting the thickness shell about a central axis.

Most preferably, the method further comprises employing the digital thickness shell imparted with the lithophane depth map within a production process.

Optionally the production process comprises an injection moulding process. The resin employed in an injection moulding process may comprise a clear resin containing a white pigment (e.g. titanium dioxide TiO₂). The addition of the white pigment provides a means for controlling the opacity of the optical illusion device. The method may further comprise adding an optical brightener to the resin. The addition of the optical brightner provides a means to control the hue of the light transmitted through the optical illusion device.

Alternatively, the production process comprises a three-dimensional printing process.

The method may further comprise adding a fluorescent or phosphorescent material to an ink or resin employed within the production process.

Most preferably the method further comprises adding opaque microparticles to an ink or resin employed within the production process. Preferably the microparticles have an average diameter between 1 and 100 microns. The microparticles may be substantially spherical, lenticular or flake shaped. The microparticles may comprise aluminium spherical particles. The aluminium spherical particles preferably have an average diameter between 10 and 20 microns.

According to a second aspect of the present invention there is provided an optical illusion device comprising a thickness shell having a negative image forming surface wherein the negative image forming surface comprises a registered lithophane depth map imparted thereon.

Most preferably the image of the negative image forming surface comprises an image of the head of a humanoid figure.

Preferably the thickness shell is made from a plastic material. The plastic material may comprise a white pigment (e.g. titanium dioxide TiO₂) and or an optical brightener.

The thickness shell may be formed from a fluorescent or a phosphorescent material.

Most preferably the thickness shell comprises a plurality of microparticles. Preferably the microparticles have an average diameter between 1 and 100 microns. The microparticles may be substantially spherical, lenticular or flake shaped. The microparticles may comprise aluminium spherical particles. The aluminium spherical particles preferably have an average diameter between 10 and 20 microns.

Embodiments of the second aspect of the invention may comprise features to implement the preferred or optional features of the first aspect of the invention or vice versa.

According to a third aspect of the present invention there is provided an optical illusion device comprising a lithophane image wherein the material forming the lithophane image comprises a plurality of microparticles.

Preferably the microparticles have an average diameter between 1 and 100 microns. The microparticles may be substantially spherical, lenticular or flake shaped. The microparticles may comprise aluminium spherical particles. The aluminium spherical particles preferably have an average diameter between 10 and 20 microns.

Preferably the material forming the lithophane image comprises a plastic material. The plastic material may comprise a white pigment (e.g. titanium dioxide TiO₂) and or an optical brightener.

The material forming the lithophane image may comprise a fluorescent or a phosphorescent material.

Embodiments of the third aspect of the invention may comprise features to implement the preferred or optional features of the first or second aspects of the invention or vice versa.

According to a fourth aspect of the present invention there is provided a method of producing an optical illusion device the method comprising producing a lithophane image from a material comprising a plurality of microparticles.

Embodiments of the fourth aspect of the invention may comprise features to implement the preferred or optional features of the first to third aspects of the invention or vice versa.

### BRIEF DESCRIPTION OF DRAWINGS

There will now be described, by way of example only, various embodiments of the invention with reference to the drawings, of which:

FIG. 1 presents a flow chart of the method of production of an optical illusion device in accordance with an embodiment of the present invention; and

FIG. 2 presents images of an optical illusion device at various stages of its production in accordance with the method of production of FIG. 1.

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION

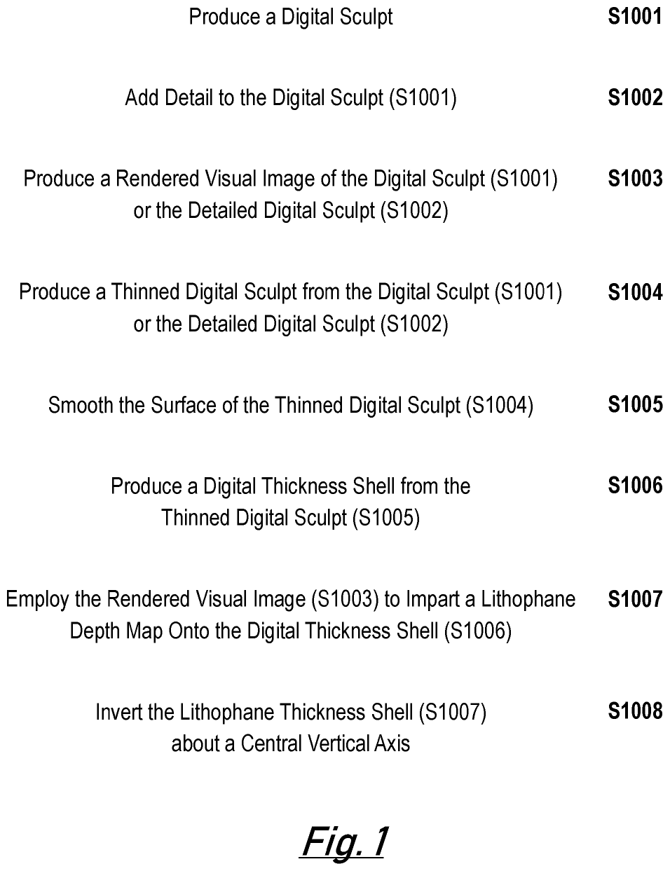

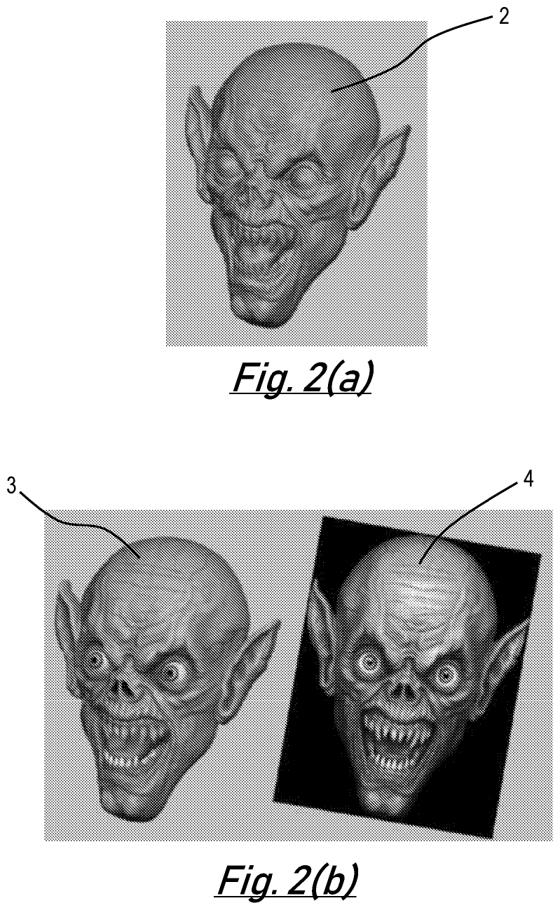

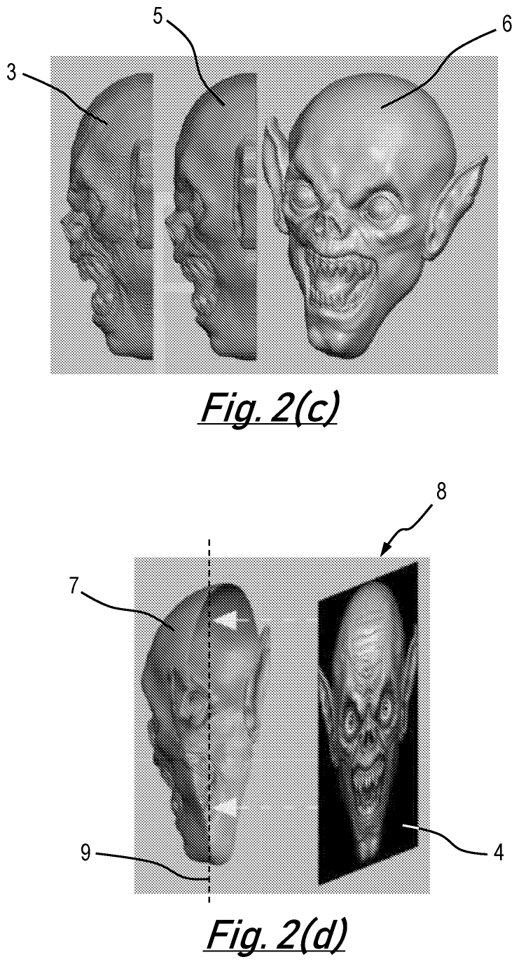

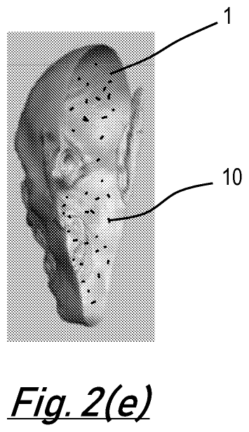

A method of producing an optical illusion device, as depicted generally be reference numeral 1, will now be described with reference to FIGS. 1 and 2. In particular, FIG. 1 presents a flow chart of a method of production of the optical illusion device 1 while FIG. 2 presents images of the optical illusion device 1 at various stages of its production.

The first stage of the method presented with FIGS. 1 and 2 involves the creation of a digital sculpt 2 which is to be the subject of the optical illusion (S1001). The digital sculpt 2 may be generated from a two-dimensional image or by creating an original sculpt. If a two-dimensional image is employed to produce the digital sculpt 2 then it is preferable for the digital sculpt 2 to be made to match the parameters of the two-dimensional image when viewed from a substantially perpendicular viewing angle. In the presently described example the digital sculpt 2 is a representation of the face of a goblin, although the head of any humanoid figure could equally well be employed.

If a two-dimensional image is employed to create the digital sculpt 2, then this may be in the form of an existing photographic image or alternatively a suitable original image may be generated. Generation of the two-dimensional image may be achieved in a variety of ways e.g. using traditional photographic and or digital processing technologies. Manipulation of the values of the two-dimensional image may also be carried out. This includes, but is not limited to manipulation of: colour; brightness; exposure; saturation; vibrancy; shadows; and highlights, to produce a greyscale image. If a photographic image is employed to create the digital sculpt 2 then it is preferable for the parameters of the digital sculpt 2 to match the parameters of the original image when viewed from a substantially perpendicular viewing angle.

The second stage of the process presented in FIGS. 1 and 2 is optional, and comprises the creation of a more detailed digital sculpt 3 (S1002) by adding detail or decoration to the digital sculpt 2. This detail or decoration may involve creating embossed and debossed areas; image enhancement based on the original two-dimensional image to create a ‘photorealistic’ image; turning the digital sculpt 2 into greyscale; and or adding tonal balancing, shadow depth, highlights and reflections to the digital sculpt 2. Adding detail at this stage helps maximise the effects of the final product produced at the end of the presently described process.

The third stage of the process presented in FIGS. 1 and 2 is to create a rendered visual image 4 of the digital sculpt 2 or the detailed digital sculpt 3 (S1003).

The next stage of the process involves create a thinned digital sculpt 5 by altering the depth proportions and or angles and or surfaces of the digital sculpt 2 or the detailed digital sculpt 3 (S1004). Such procedures are known in the art and are primarily employed to eliminate undercuts and other features which would be problematic in any future injection moulding techniques. At the end of this stage, the thinned digital sculpt 5 will look proportionally correct to any original image from which it was produced when viewed from the front, but will appear ‘squashed’ when viewed from the side. As will be discussed in further detail below, employing the thinned digital sculpt 5 provides the final product produced with additional technical advantages over those products known in the art.

The next stage of the process presented in FIGS. 1 and 2 is again optional, and comprises smoothing the surfaces of the thinned digital sculpt 5 (S1005) to produce a thinned digital sculpt with minimal surface detail 6. This stage is particularly useful if stage (S1002) has previously been employed to create a detailed digital sculpt 3. Fine physical detail is not required on the thinned digital sculpt 6, as all “photographic” detail of the final product is provided through the incorporation of the rendered visual image 4, created in stage (1003), as will be described in further detail below.

The next stage of the process involves the creation of a digital thickness shell 7 from the thinned digital sculpt 5 or the smoothed digital sculpt 6 (S1006). Such procedures are known in the art and are employed to effectively convert a solid digital object into a digital hollow mould that exhibits an outer surface having the same profile as the original solid digital object.

The penultimate stage of the process presented in FIGS. 1 and 2 comprises employing the rendered visual image 4 of the detailed digital sculpt 3, produced at stage (S1003,) to impart a lithophane depth map onto the digital thickness shell 7 (S1007). This process results in the production of a lithophane thickness shell 8.

There are two methods for completing this stage of the process. The first option is to project the rendered visual image 4 into the digital thickness shell 7, and then using embossing and or debossing techniques, impart the lithophane depth map onto the digital thickness shell 7. The level of embossing and or debossing is determined by the relative greyscale values of the rendered visual image 4. It is noted that depending on the software application being employed, and its embossing and debossing ability, the image of the rendered visual 4 may need its greyscale values inverted.

The second option is to project the rendered visual 4 image onto the positive or outer surface of the digital thickness shell 7 and then emboss the image into this surface. This embossed digital thickness shell 7a is then employed to deboss the internal surface of the original digital thickness shell 7. Put another way, the digital thickness shell 7 and the embossed digital thickness shell 7a are effectively overlapped and registered with each other. The mass of the digital thickness shell 7a is then removed from the composite structure to create the appropriately debossed surface on the digital thickness shell 7.

The final stage of the process presented in FIGS. 1 and 2 is again optional, and comprises inverting the lithophane thickness shell 8 about a central, orientated axis 9 (S1008). Employing this stage ensures the physical form in the optical illusion device 1 is representative of the original photograph, which is particularly important if the optical illusion device 1 is based on a two-dimensional image a person.

A three-dimensional printing technique is one of several techniques than can then be employed to physically produce the optical illusion device 1.

Alternatively, the optical illusion device 1 can be produced by an injection moulding process. The resin employed in an injection moulding process to produce the optical illusion device 1 may comprise a clear resin containing a white pigment (e.g. titanium dioxide TiO₂) to control the opacity of the optical illusion device 1. Adding the white pigment provides the optical illusion device 1 with a natural ‘sepia’ colour. The hue of the light transmitted through the optical illusion device 1 can be changed from the natural ‘sepia’ colour to a more black and white look by also adding an optical brightener to the resin.

It will be appreciated by the skilled reader that the thickness of the lithophane thickness shell 8, in part, defines the light transmittance in the final optical illusion device 1 i.e. thicker sections will allow less light through, while thinner sections will let more light through (range). This range will ultimately set the contrast parameters for the optical illusion device 1 and can be adjusted to suit the particular subject.

The overall result is that the optical illusion device 1 comprises a negative image forming surface, or inverted, sculpted model shell with a registered lithophane depth map imparted thereon. Therefore, when the optical illusion device 1 is viewed from various angles (and with a light source placed behind it), the inverted surface appears to the viewer as a positive or convex model with a photographic image applied to the profiled surface. The illusion created is of a ‘panning’, photographic image/3D object, complete with light and shade due to the presence of the lithophane depth map.

As referred to above the step S1004 employing the thinned digital sculpt 5 provides a device that is shallower than most devices described in the prior art. This means that the optical illusion device 1 requires less material to manufacture and thus is more efficient and economical to produce. The employment of less material also makes the optical illusion device 1 easier to light to observe the desired illusion. Finally, since the optical illusion device 1 is shallower the field of view of the device is increased when compared with many of those devices known in the art.

The optical illusion device 1 may be manufactured from any suitable material e.g. a plastic material. In alternative embodiments, the optical illusion device 1 may be manufacture from fluorescent or phosphorescent materials. In these embodiments, it is preferable to invert the rendered visual image 4 before imparting the lithophane depth map onto the digital thickness shell 7 (S1007).

The present invention employs a lithophane depth map to enhance a negative bust illusion device by adding photorealistic detail. The described method allows the optical illusion device 1 to be produced in a commercially cost-effective way using a single process e.g. injection moulding.

The material employed to produce the optical illusion device 1 can be varied, to give different visual effects. For example, different colours or reactive materials (e.g. translucent or ‘glow-in-the-dark’ phosphorescent materials may be employed.

Contrast within the optical illusion device 1 produced by the above methods is found to be significantly improved by adding opaque (to visible light) microparticles 10 to the ink or resin employed in the production process. Preferably the microparticles 10 have an average diameter between 1 and 100 microns. The microparticles may be substantially spherical, lenticular or flake shaped. An example of microparticles employed with the presently described are aluminium spherical particles having an average diameter between 10 and 20 microns. These aluminium particles provide a metallic effect to the appearance of the optical illusion device 1 when not backlit. However, when the optical illusion device 1 is backlit the contrast and detail that can be achieved is very close to photographic quality.

The applicants have also found that the contrast within an optical illusion device comprising a standard lithophane image is significantly improved by adding the opaque (to visible light) microparticles 10 to the ink or resin employed within in the production process.

The described methods of production provide versatility in the form of the optical illusion device 1 produced and their deployment. For example, the optical illusion device 1 may be:
1) a standalone product that employs an ambient backlight (e.g. on windowsill);
2) one that incorporates an artificial background illumination (e.g. a light-box, ‘mood-lamp’, incorporated into lampshade or light fixture;
3) Self illuminating. Self illumination can be produced by:
   a) injection moulding with plastic containing glow-in-the-dark pigment; or
   b) applying a glow-in-the-dark coating to the rear of the optical illusion device 1, so the light glows through the material
4) Enhanced illumination: e.g. Fluorescing: achieved by adding a pigment to the plastic, or a coating to the rear, that fluoresces under specific wavelengths e.g. UV reactive pigments which fluoresce under a UV wavelength “backlight”; and
5) Enhanced contrast achieved through the incorporation of opaque microparticles within the ink or resin employed to produce the device.

An optical illusion device and method of production is described. The method comprises producing a digital sculpt. A rendered visual image and a thinned digital sculpt are then produced from the digital sculpt. Next a digital thickness shell is produced from the thinned digital sculpt. Finally, the rendered visual image is employed to impart a lithophane depth map onto the digital thickness shell. The overall result is an optical illusion device comprising a negative image forming surface with a registered lithophane image imparted on thereon. When the optical illusion device is viewed from various angles (and with a light source placed behind it), the negative image forming surface appears to the viewer as a positive or convex model with a photographic image applied to the profiled surface. The illusion created is of a ‘panning’, three-dimensional photographic image, complete with improved detail due to the presence of the lithophane depth map.

Throughout the specification, unless the context demands otherwise, the term “comprise” or “include”, or variations such as “comprises” or “comprising”, “includes” or “including” will be understood to imply the inclusion of a stated integer or group of integers, but not the exclusion of any other integer or group of integers.

Furthermore, reference to any prior art in the description should not be taken as an indication that the prior art forms part of the common general knowledge.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A method of production of an optical illusion device, the method comprising:
producing a digital sculpt;
producing a rendered visual image of the digital sculpt;
producing a thinned digital sculpt from the digital sculpt;
producing a digital thickness shell from the thinned digital sculpt;
employing the rendered visual image to impart a lithophane depth map onto the digital thickness shell to produce a lithophane thickness shell; and
producing the optical illusion device from the lithophane thickness shell.

2. A method of production of an optical illusion device as claimed in claim 1 wherein the digital sculpt is produced from a two-dimensional image.

3. A method of production of an optical illusion device as claimed in claim 2 wherein manipulation of the two-dimensional image is carried out to produce a greyscale image.

4. A method of production of an optical illusion device as claimed in claim 3 wherein the manipulation of the two-dimensional image comprises manipulation of one or more of the following properties of the two-dimensional image; colour; brightness; exposure; saturation; vibrancy; shadows; and highlights.

5. A method of production of an optical illusion device as claimed in claim 1 wherein the method further comprises adding detail to the digital sculpt.

6. A method of production of an optical illusion device as claimed in claim 5 wherein adding detail to the digital sculpt comprises one or more of the following: creating embossed and debossed areas; image enhancement based on an original two-dimensional image to create a ‘photorealistic’ image; turning the digital sculpt into greyscale; and adding tonal balancing, shadow depth, highlights and reflections to the digital sculpt.

7. A method of production of an optical illusion device as claimed in claim 1 wherein producing the thinned digital sculpt comprises altering the depth proportions and or angles and or surfaces of the digital sculpt.

8. A method of production of an optical illusion device as claimed in claim 1 wherein imparting the lithophane depth map onto the digital thickness shell comprises projecting the rendered visual image into the digital thickness shell.

9. A method of production of an optical illusion device as claimed in claim 8 wherein the method further comprises employing either or both of embossing and debossing techniques to impart the lithophane depth map onto the digital thickness shell.

10. A method of production of an optical illusion device as claimed in claim 1 wherein imparting the lithophane depth map onto the digital thickness shell comprises projecting the rendered visual image onto a positive or outer surface of the digital thickness shell.

11. A method of production of an optical illusion device as claimed in claim 10 wherein the method further comprises employing embossing techniques to impart the lithophane depth map onto the outer surface of the digital thickness shell.

12. A method of production of an optical illusion device as claimed in claim 11 wherein the method further comprises employing the embossed digital thickness to deboss the internal surface of the digital thickness shell.

13. A method of production of an optical illusion device as claimed in claim 1 wherein the method further comprises inverting greyscale values of the rendered visual image.

14. A method of production of an optical illusion device as claimed in claim 1 wherein the method further comprises smoothing one or more surfaces of the thinned digital sculpt.

15. A method of production of an optical illusion device as claimed in claim 1 wherein the method further comprises inverting the thickness shell about a central axis.

16. A method of production of an optical illusion device as claimed in claim 1 wherein the method further comprises employing the digital thickness shell imparted with the lithophane depth map within a production process.

17. A method of production of an optical illusion device as claimed in claim 16 wherein the production process comprises an injection moulding process.

18. A method of production of an optical illusion device as claimed in claim 17 wherein a resin employed in the injection moulding process comprises a clear resin containing a white pigment.

19. A method of production of an optical illusion device as claimed in claim 18 wherein the method further comprises adding an optical brightener to the resin.

20. A method of production of an optical illusion device as claimed in claim 16 wherein the production process comprises a three-dimensional printing process.

21. A method of production of an optical illusion device as claimed in claim 16 wherein the method further comprises adding a fluorescent or phosphorescent material to an ink or resin employed within the production process.

22. A method of production of an optical illusion device as claimed in claim 16 wherein the method further comprises adding opaque microparticles to an ink or resin employed within the production process.

23. A method of production of an optical illusion device as claimed in claim 22 wherein the microparticles have an average diameter between 1 and 100 microns.

24. A method of production of an optical illusion device as claimed in claim 22 wherein the microparticles are substantially spherical, lenticular or flake shaped.

25. A method of production of an optical illusion device as claimed in claim 22 wherein the microparticles comprise aluminium spherical particles.

26. A method of production of an optical illusion device as claimed in claim 25 wherein the aluminium spherical particles have an average diameter between 10 and 20 microns.

27. An optical illusion device comprising a thickness shell having a negative surface, the shape of the negative surface providing an optical illusion of a positive image for an observer, wherein the negative surface comprises a registered lithophane depth map of the positive image imparted thereon.

28. An optical illusion device as claimed in claim 27 wherein an image of the negative surface is shaped to form an image of a head of a humanoid figure.

29. An optical illusion device as claimed in claim 27 wherein the thickness shell is made from a plastic material.

30. An optical illusion device as claimed in claim 29 wherein the plastic material comprises either or both of a white pigment and an optical brightener.

31. An optical illusion device as claimed in claim 27 wherein the thickness shell is formed from a fluorescent material or a phosphorescent material.

32. An optical illusion device as claimed in claim 27 wherein the thickness shell comprises a plurality of microparticles.

33. An optical illusion device as claimed in claim 32 wherein the microparticles have an average diameter between 1 and 100 microns.

34. An optical illusion device as claimed in claim 32 wherein the microparticles are substantially spherical, lenticular or flake shaped.

35. An optical illusion device as claimed in claim 32 wherein the microparticles comprise aluminium spherical particles.

36. An optical illusion device as claimed in claim 35 wherein the aluminium spherical particles have an average diameter between 10 and 20 microns.
